(19) United States
(12) Patent Application Publication
(10) Pub. No.: US 2012/0056060 A1
(43) Pub. Date: Mar. 8, 2012

(54) ANTLER RACK ASSEMBLY

(76) Inventor: Greg Parton, Lampe, MO (US)

(21) Appl. No.: 12/876,381

(22) Filed: Sep. 7, 2010

(51) Int. Cl. F16B 45/00; F16M 13/00

(52) U.S. Cl. 248/304; 248/309.1; 248/316.7

(57) ABSTRACT

An antler rack assembly that may be used to attach and mount antlers onto a tree or other stationary object in an easy and quick manner. The antler rack assembly according to the present invention allows for the insertion of antlers into spring clips that extend from tubing. The spring clips allow for the insertion of the antlers and therefore places the antlers in a stable vertical position. Another tube is used to insert the antler rack into the tree or other stationary object and therefore creates the antler rack assembly in accordance with the present invention.

### BACKGROUND OF THE INVENTION

1. Field of Invention

The present invention relates to an antler rack assembly that provides a means to mount a pair of antlers.

2. Description of Related Art

Many outdoorsmen hunt various types of game. Many hunters are particularly interested in hunting deer, moose or other types of animals that have antlers. Antlers are a symbol of achievement for many hunters. Hunters attempt to hunt prey with the largest antlers and the greatest numbers of points associated with the antlers. On many occasions, a taxidermist processes the game and the head of the animal may be displayed on a mounting piece. On other occasions the antlers are simply removed from the animal and the antlers are displayed on a mounting piece.

In addition to mounting antlers on a mounting piece, many times hunters use antlers as a means to attract or lure deer by rattling the antlers. Rattling antlers is a skill that many hunters have honed in order to imitate two fighting bucks. The rattling of the antlers helps to draw attention and therefore attract other bucks based solely on the rattling sound. The actual rattling of the antlers involves the ramming together of the antlers and twisting them in opposite directions and then repeating the crashing sound. Many times hunters repeat this rattling sound and action several times while hunting in order to attract deer.

One shortcoming of using antlers is the necessity to drop the antlers and prepare to aim and shoot a deer that may be attracted to the rattling sounds. A hunter must store the antlers and then retrieve the gun to aim and then shoot the deer that may be in the area. It would therefore be advantageous to have a device that may be easily mounted to a tree or other stationary object to quickly store the antlers and then simultaneously remove a bow or a gun from a storage hook provided thereon.

### SUMMARY OF THE INVENTION

The present invention relates to an antler rack assembly for mounting antlers on a stationary object comprising: a first tube, wherein said first tube includes a threaded end, where said threaded end provides means to mount the rack assembly into a stationary object; a second tube, wherein said second tube includes a means to insert antlers; and a means to connect the first tube and the second tube. The means to connect the first tube and second tube may include a connecting bolt that extends through the first tube and the second tube, where the connecting bolt is locked into place with a nut. The first tube may further include an accessory hook at the opposite end of the threaded end. The means for insertion of antlers may include a spring clip at each end of the second tube, where each spring clip includes clip arms that resiliently provide the means for the insertion of antlers. The threaded end is used to insert a rack assembly into a stationary object.

### BRIEF DESCRIPTION OF DRAWINGS

FIG. 1 depicts an antler rack assembly according to the present invention.

FIG. 2 depicts a top view of the antler rack assembly according to the present invention.

FIG. 3 depicts a front view of the antler rack assembly according to the present invention mounted onto a tree.

FIG. 4 depicts a side view of the antler rack according to the present invention mounted to a tree.

### DETAILED DESCRIPTION

The present invention relates to an antler rack assembly that may be used to attach and mount antlers onto a tree or other stationary object in an easy and quick manner. The antler rack assembly according to the present invention allows for the insertion of antlers into spring clips that extend from tubing. The spring clips allow for the insertion of the antlers and therefore places the antlers in a stable vertical position. Another tube is used to insert the antler rack into the tree or other stationary object and therefore creates the antler rack assembly in accordance with the present invention.

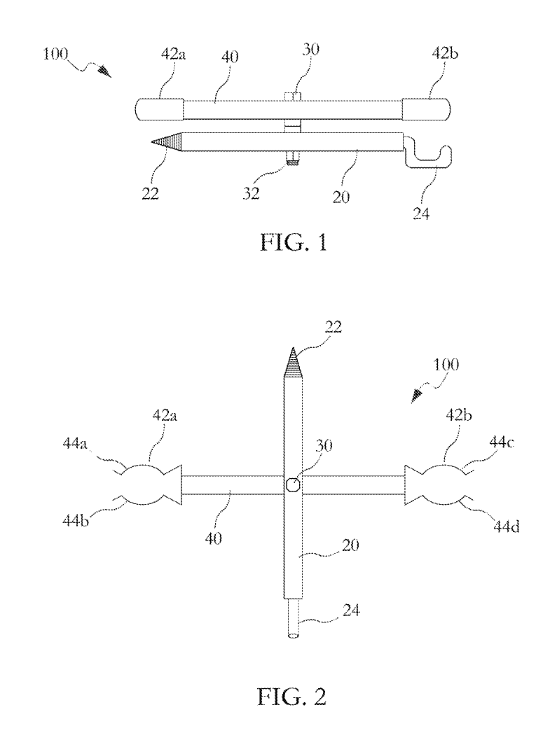

In reference to FIG. 1, a side view of the antler rack assembly 100 is depicted. The antler rack 100 includes a first tube 20 and a second tube 40. The first tube 20 and second tube 40 are joined together through the use of a connecting bolt 30 that extends through both tubes and is locked into place with a nut 32. At each end of the second tube 40, spring clips 42a, 42b are provided. The spring clips 42a, 42b provides a means for the insertion of antlers. The first tube 20 includes a threaded end 22 and an accessory hook 24 at the opposite end thereof. The threaded end 22 is used to insert the rack assembly into a tree or a solid stationary object.

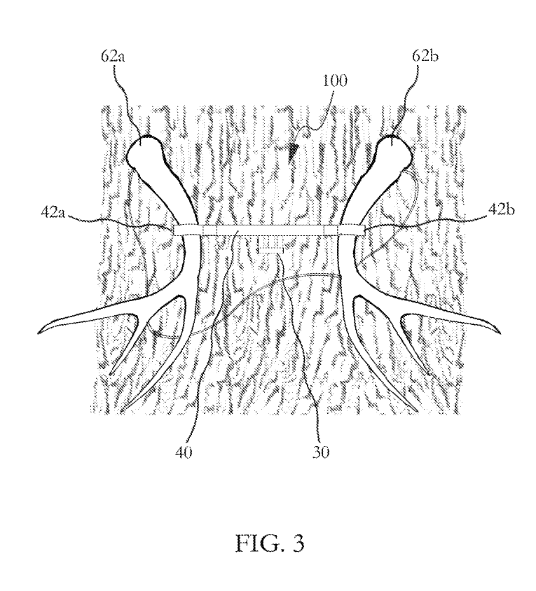

FIG. 2 depicts a top view of the antler rack assembly 100 according to the present invention. As clearly seen, the first tube 20 and second tube 40 are connected with the connecting bolt 30. The position of the antler rack 100 shown in FIG. 2 is a position suitable for mounting the rack assembly into a stationary object. The second tube 40 and first tube 20 are perpendicular to each other where the spring clips 42a, 42b extend at the outer ends of the second tube 40. The spring clips 42a, 42b include clip arms 44a, 44b for spring clip 42a and clip arms 44c, 44d for spring clip 42b. The clip arms rigidly expand to allow for the insertion of an antler into each opening between the respective clip arms of each spring clip. Once the antler is inserted in these clip arms the antlers are held in a stationary, stable and vertical position.

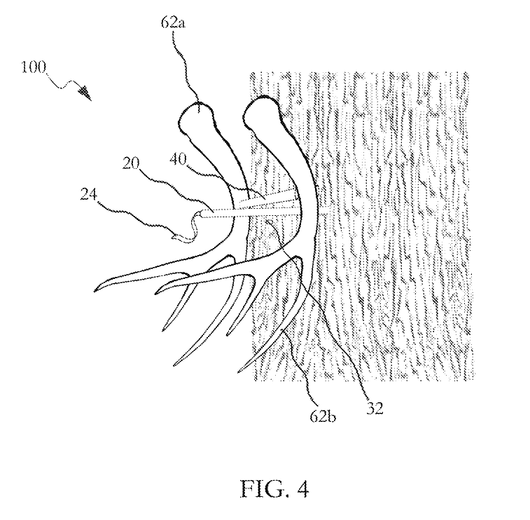

A front view of antlers 62a, 62b inserted into the antler rack 100 is depicted in FIG. 3. As shown, the antler 62a inserts into spring clip 42a and antler 62b inserts into the spring clip 42b. The rack assembly 100 is mounted into a tree in this particular embodiment. It's noted that although shown as being inserted into a tree, the rack assembly 100 may be inserted into any stationary object placing the antlers in a vertical position. The second tube 40 is shown extending between the antlers 62a, 62b.

FIG. 4 depicts a side view of the rack assembly 100 inserted into a tree. FIG. 4 provides a more perspective view of the rack assembly where the first tube 20 is shown inserted into and extending from the tree, and an accessory hook 24 is shown at the opposite end of the first tube 20. The second tube 40 extends between the antlers 62a, 62b. Once the antlers are mounted in this manner the rack assembly is available for use and provides a means for hanging antlers after use by a hunter. The rack assembly 100 is a device that ensures that minimal damage is done to the antlers while using them in a mounting function. The rack assembly 100 secures the antlers into place and provides an easy method to attach the antlers within the assembly. The flexible spring clips securely hold the antlers in a secure place and allows for the simple removal and disassembly of the rack assembly as desired. Also the rack assembly may be used to store the hunter's gun or bow onto the accessory hook 24 while the hunter rattles the antlers. The use of the rack assembly according to the present invention provides a quick, quiet, and easy means for a hunter to store their rattling antlers when a buck comes approaching attracted to the rattling sound. The rack assembly allows the hunter to place the horns into the rack and then ease their bow or gun from the sentry hook in a quick and easy motion.

What is claimed is:

1. An antler rack assembly for mounting antlers on a stationary object comprising:
a. a first tube, wherein said first tube includes a threaded end, where said threaded end provides means to mount the rack assembly into a stationary object;
b. a second tube, wherein said second tube includes a means to insert antlers; and
c. a means to connect the first tube and the second tube.

2. The antler rack assembly according to claim number 1, wherein said means to connect the first tube and second tube includes a connecting bolt that extends through the first tube and the second tube, where said connecting bolt is locked into place with a nut.

3. The antler rack assembly according to claim number 1, where in said first tube further includes an accessory hook at the opposite end of the threaded end.

4. The antler rack assembly according to claim number 1, where said means for insertion of antlers includes a spring clip at each end of the second tube, where each spring clip includes clip arms that resiliently provide the means for the insertion of antlers.

5. The antler rack assembly according to claim 1, where the threaded end is used to insert a rack assembly into a stationary object.
